(19) United States
(12) Patent Application Publication
(10) Pub. No.: US 2006/0157152 A1
(43) Pub. Date: Jul. 20, 2006

(54) Beverage dispenser with game controller

(76) Inventors: Peter F. Wolski, Chicago, IL (US); Gregory Billman, Hoffman Estates, IL (US); Santhosh Kumar, Woodridge, IL (US); Kyle B. Elsom, Batavia, IL (US); Mark R. Lytell, Glendale Heights, IL (US); David Breit Gist, Grayslake, IL (US); E. Scott Sevcik, Crystal Lake, IL (US); Kevin Brandt, Barrington, IL (US); Andrew Sanguinet, Oak Park, IL (US); Michael Piontek, Chicago, IL (US)

Correspondence Address: PYLE & PIONTEK, 221 N. LASELLE STREET, SUITE 850, CHICAGO, IL, 60601, US

(21) Appl. No.: 11/202,609

(22) Filed: Aug. 12, 2005

Related U.S. Application Data
(60) Provisional application No. 60/601,738, filed on Aug. 13, 2004.

(51) Int. Cl. B67D 5/56

(52) U.S. Cl. 141/275; 222/129.1

(57) ABSTRACT

A beverage dispenser apparatus and method for dispensing a beverage, be it soda, beer or frozen “slushy” type is provided with a direct or indirect mounted game type controller for operating and dispensing the beverage. Additional features such as game displays, audio and or additional dispensing functions, such as adding flavoring, and vending may be controlled via the game type control. The vending operation may be initiated by money deposits or acceptance of some type card such as a debit, credit or other card.

### DISCLOSURE

This application claims benefit of U.S. Provisional Patent Application Ser. No. 60/601,738 entitled “Beverage Dispenser With Game Controller,” filed on Aug. 13, 2004. This application and invention relates to a beverage dispenser, and more particularity to a beverages dispenser having a game type interface for controlling the functions of the beverage dispenser, such as, but not limited to, one for dispensing drink or semi-frozen products.

### BACKGROUND OF THE INVENTION

Heretofore, it has been known to provide a beverage dispenser, including remote towers, for various beverages such as, for example, soda or “slushy” type products, with functional controls which are operated by, for example, pressing a cup against a lever associated with the dispensing nozzle or pushing a button on the dispenser to select a drink or flavor. For example, see U.S. Pat. No. 4,890,774, which shows buttons on a dispenser to control the size of the drink dispensed.

### SUMMARY OF THE INVENTION

The present invention relates to a method and apparatus for controlling a beverage dispenser, be it for drink, such as soda, or a slushy type product such as a frozen or iced product, as for example frozen carbonated beverages, with a multi-position game type controller or customer interface. The game type controller is of the type utilized on controlling computer games, say a lever, joystick or joysticks with one or more buttons or a multiple button controller. The novel controller of the present invention, apparatus and method can be mounted directly on the dispenser and/or connected to the dispenser by cabling as in a computer game. The controller can be used retrofitted to an existing dispenser and/or built into a new dispenser. Either type dispenser can have game type functions, audio functions, and if desired, a monitor for displaying the games, audio and or dispenser operation. The dispenser can be coin or dollar bill operated, or made to take a debit or credit card, via an appropriate coin, bill and/or card slot on or associated with the dispenser.

### BRIEF DESCRIPTION OF THE DRAWINGS

FIG. 1 is a schematic perspective view of a dispenser of the present invention fitted with a joystick type control mounted by cable to the dispenser.

FIG. 2 is a schematic view of a dispenser illustrating overall operation.

FIG. 3 is a further schematic view showing a variety of control systems that can be used with the dispenser.

FIGS. 4A, B, C, D, E, F, G and H show other examples of the type of controller or customer interface that could be used with the dispenser method and apparatus of the present invention.

FIG. 5 is a schematic showing how one of the game type interfaces shown, for example, in FIGS. 4A to 4D can be installed on a dispenser.

FIG. 6 is an enlarged view of one type controller that could be used to control a dispenser, be it a retrofitted or new dispenser.

FIG. 7 is an enlarged perspective view of another joystick type controller that could be used to control a dispenser be it a retrofitted or new dispenser.

FIG. 8 is a view of an existing dispenser retrofitted with one of the several controllers disclosed herein, and two vend slots for card, coin and or bill operation.

FIG. 9 is an enlarged perspective view of a new dispenser fitted with one of the several controllers described herein and two vend slots.

FIG. 10 is a perspective view of another style two-product dispenser with a built in video monitor therein and two game type controllers and a single vend slot.

FIG. 11 is a perspective view of yet another style two-product dispenser with a built in video monitor and showing one of two controllers installed therein and a single vend slot.

### DETAILED DESCRIPTION OF THE PREFERRED EMBODIMENTS

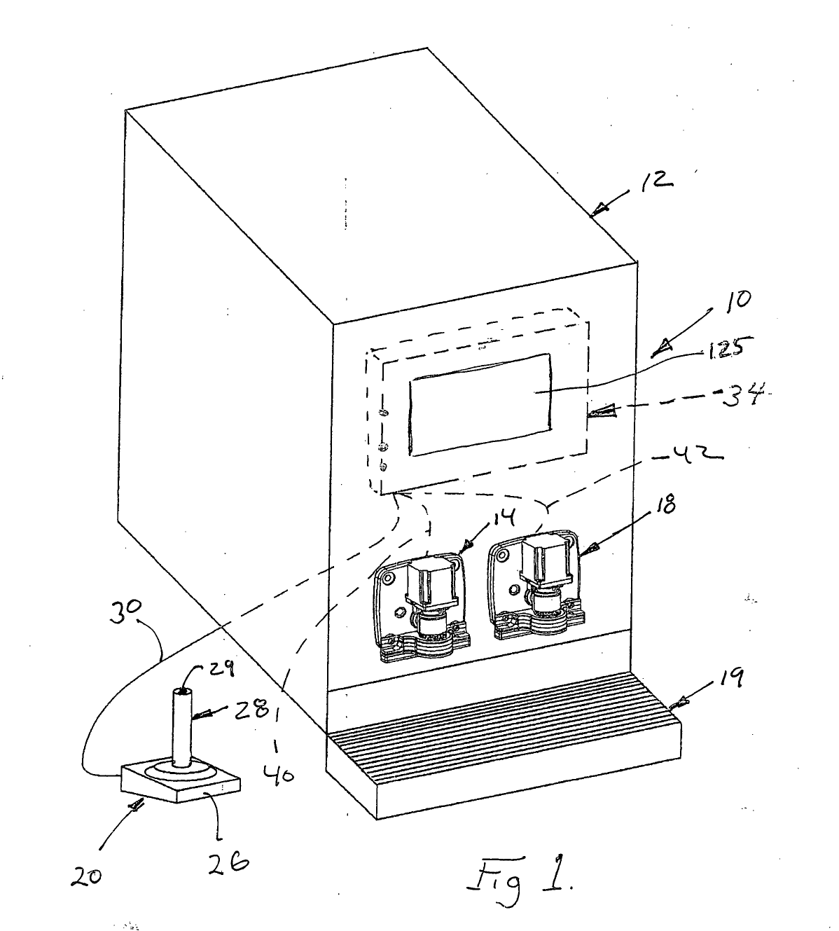

Referring to FIG. 1, a dispenser 10 is shown and has a housing 12 on which are mounted one or more, in this instance two, but could be as many as twelve or more dispensing devices 14 and 18. These devices may dispense one or more different products, be it drink, beverage, beer, or frozen products, by way of example and not limitation.

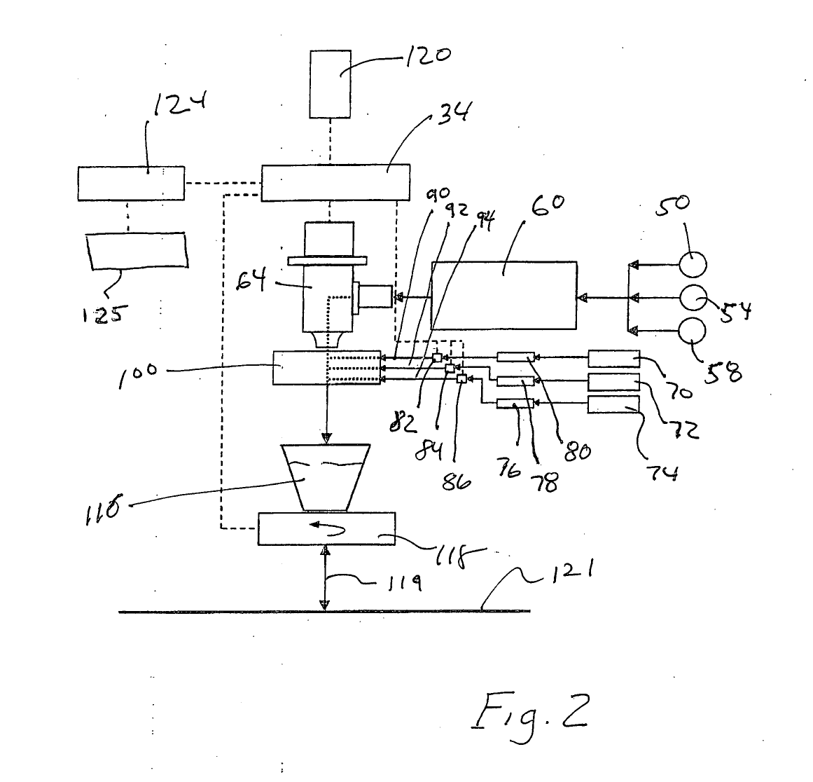

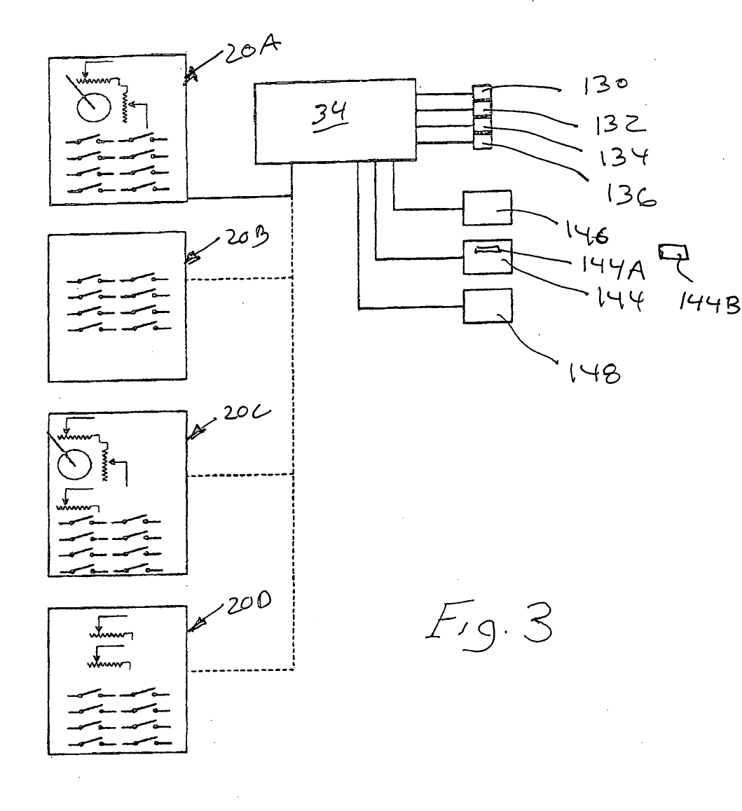

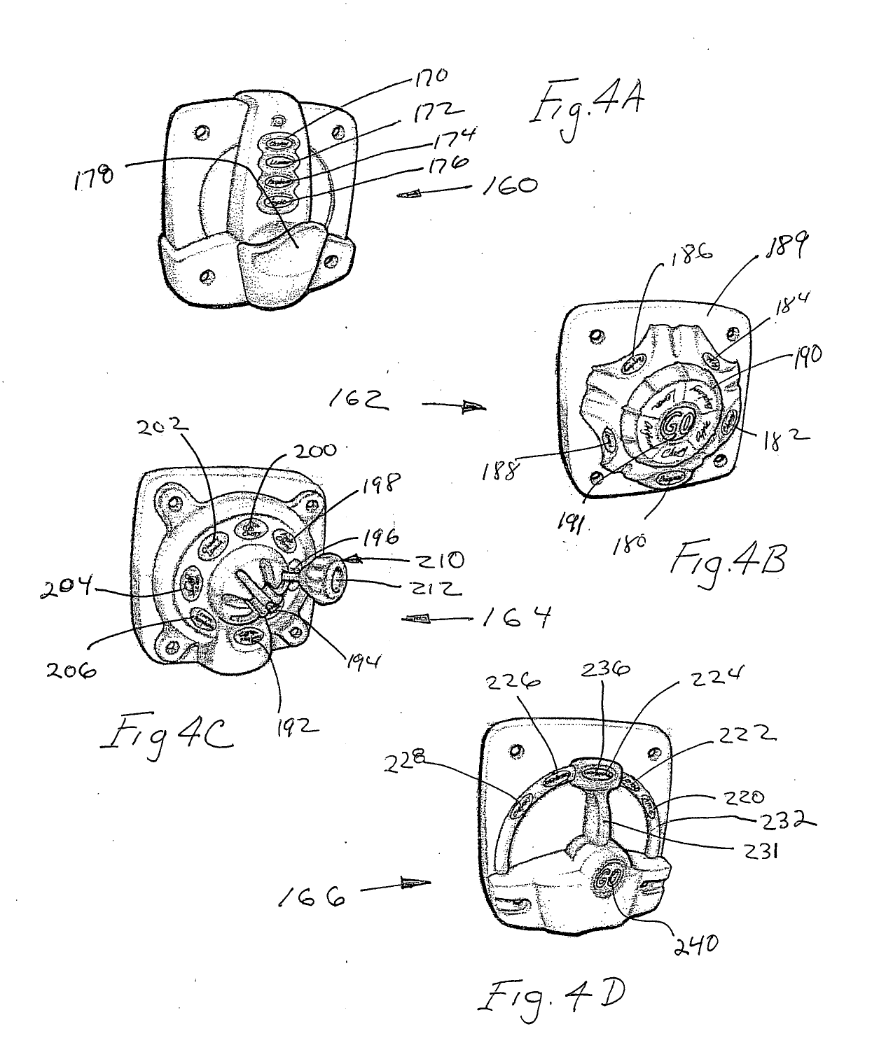

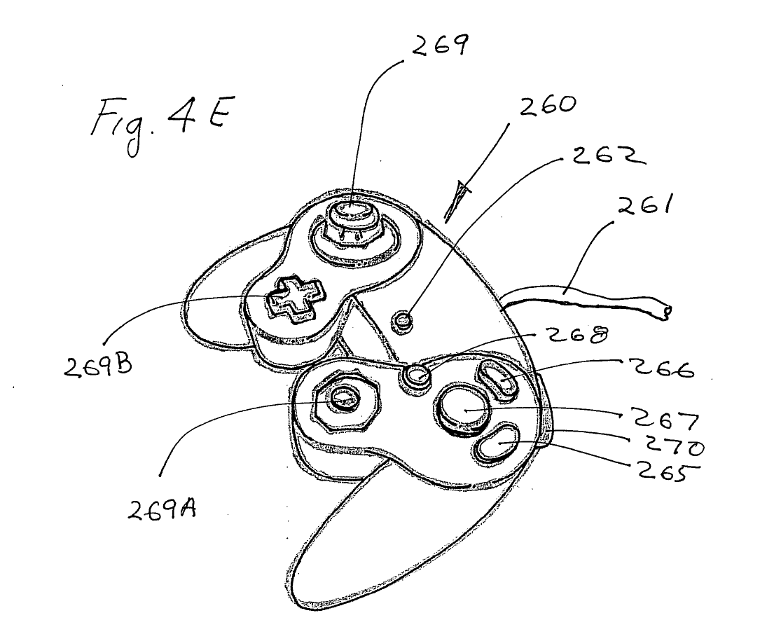

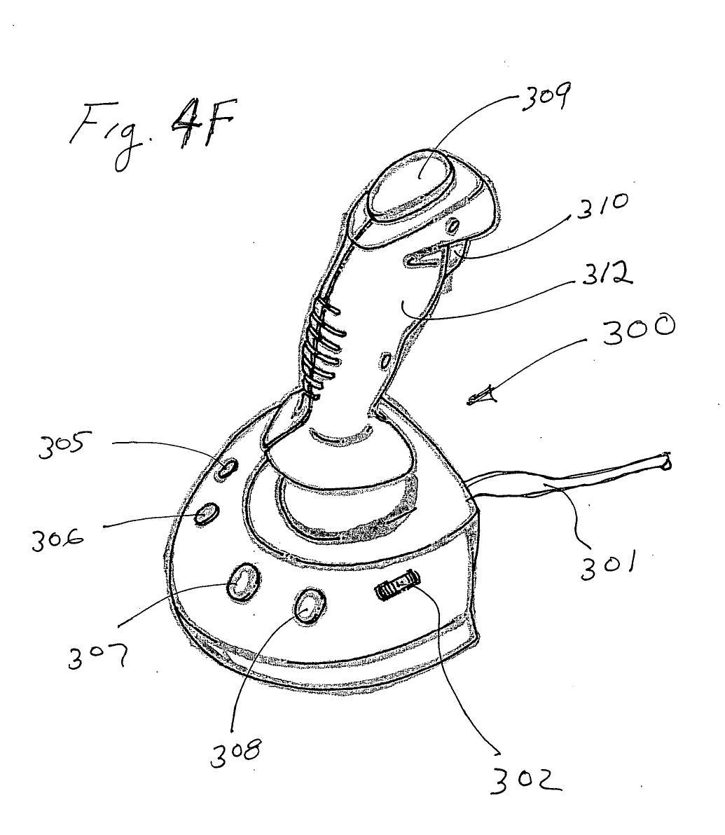

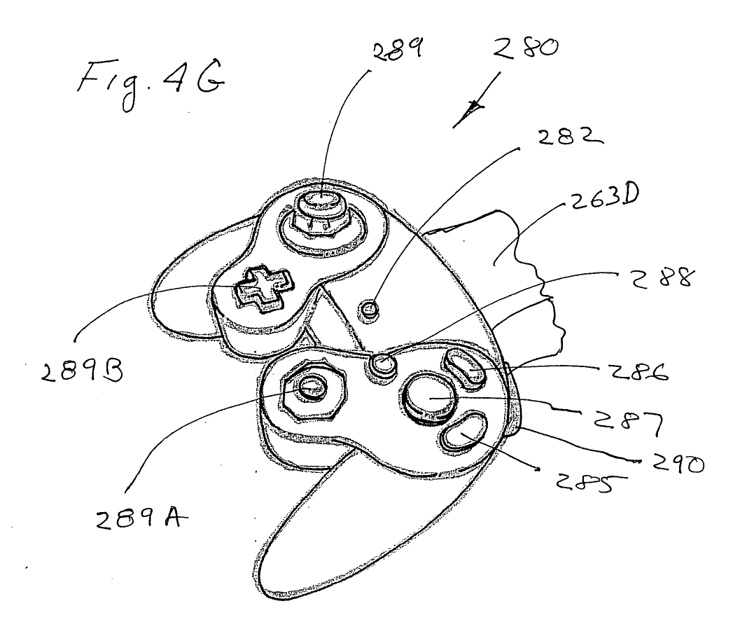

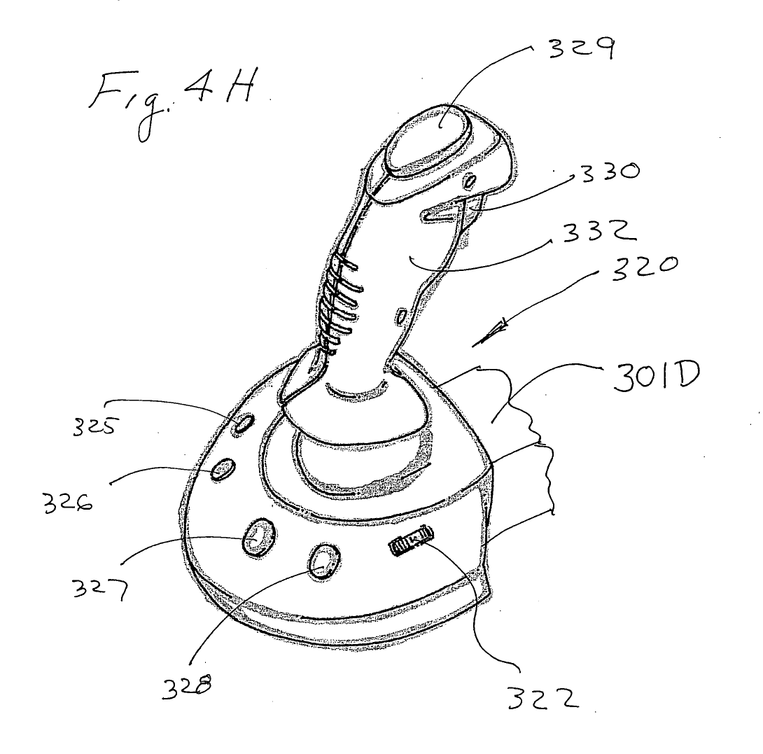

The dispensing devices 14 and 18 are, of course, connected to one or more sources of product and say, for example, additional flavorings, and could include a drink dispenser nozzle (such as 64 of FIG. 2) and a flavor mixing device (such as 100 of FIG. 2). These components 64 and 100 could be separate or integrated and also separate and/or integral with the consumer interface as will be later described with reference to FIGS. 4A to 4D and 5. The dispenser 10 may have other functions, which will be further discussed with respect to FIG. 2. The housing 12 as shown has a drip tray 19 on its front below the dispensing devices 14 and 18. The dispenser 10, in this instance has a customer interface or controller 20. In this instance, the controller 20 is in the form of a joystick, having a base 26 and at least one movable lever or joystick 28. Of course, additional control buttons such as a “gun” button 29 on the top and/or on sides of the joystick 28 could be provided. It should be understood that this controller 20 could be provided with additional functions buttons such as triggers, as is known for game controllers. While the controller could be mounted directly on to the dispenser housing 12, in this instance, it is cable connected, as is illustrated by cable 30.

The cable 30 connects to a control unit or box 34 which could be of any type, including analog, digital or microprocessor type. The dispensing devices, in this instance 14 and 18, and particularly the valves thereof are connected by wiring 40 and 42 to the control box 34 so that manipulation of the controllers, via the control box 34, controls the operation of the dispensing devices 14 and 18.

Referring now to FIG. 2, the dispenser 10, may have multiple functions which can be controlled by the controller 20. For example if the dispenser 10, were for frozen carbonated beverage, it would have a CO₂ source 50, a syrup source or sources 54, and a water source 58. These three ingredients would be directly or indirectly sent to a freezer chamber, such as a barrel, 60 and hence on demand and under operator control, via the controller 20, to a dispense nozzle 64. If desired, additional flavoring may be provided. In FIG. 2 by way of example, three additional flavors 70, 72 and 74 are shown. Of course it should be understood that there could be additional products; there could also be additional flavors. The flavors are dispensed by, in this instance, a pump or plurality of pumps 76, 78 and 80, through proportional solenoids 82, 84 and 86. These solenoids prevent dripping and assure consistent metering of the flavors. The flavors then flow via lines 90, 92, and 94, to a mixing device, flavor injector, or diametric valve 100 to join the main product flow from the dispensing nozzle 64. This construction is similar to either dispensing device 14 or 18, and the product and flavor selected are dispensed into a cup or container 116. The cup can rest upon a platform or turntable 118 which can rotate, say fast, slow or anywhere in between, and can be raised or lowered as indicated by the arrow 119 off of a surface 121. One or more or all of the above operations can be controlled via the control box 34 and the operator controller 20.

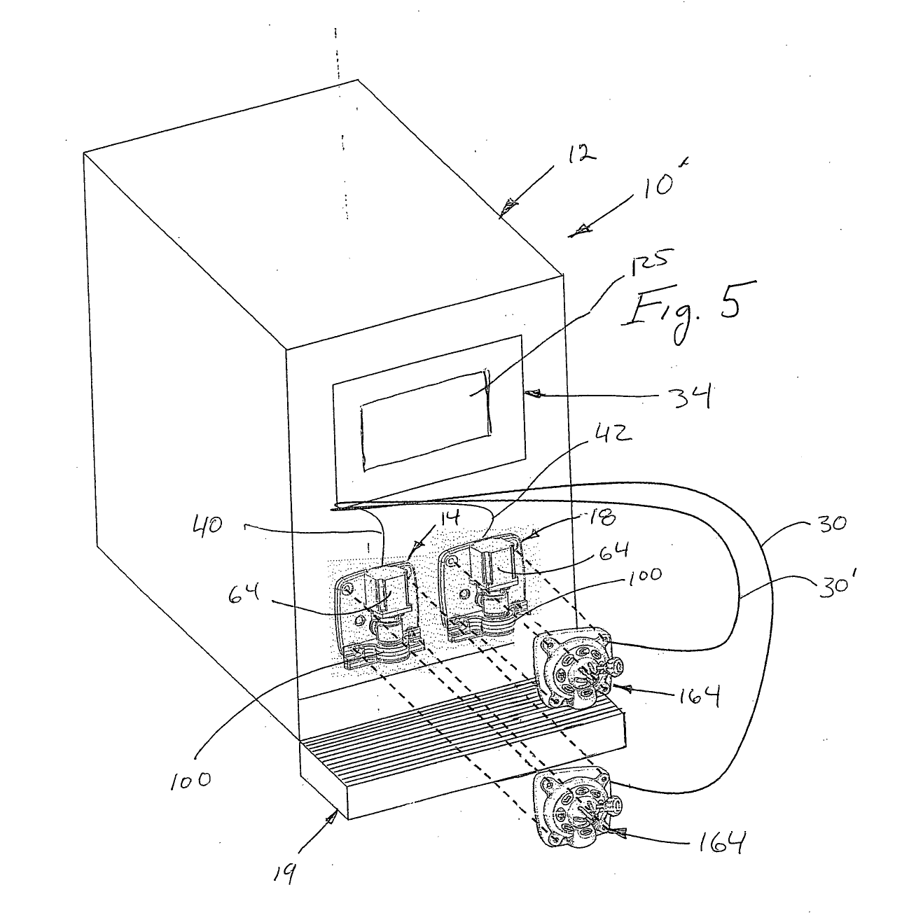

Further, the control box 34 may be fitted with and/or used to control a card, such as debit or credit, coin or money (bills) operated or vending control 120. See FIGS. 8 to 11. Additionally various game type video displays and/or audio 124 could be provided, with one or more functions thereof controlled by the controller 20. For example, the dispenser 10 could be fitted with a video monitor 125 (see FIG. 1) on which beverage dispensing functions and/or video games and audio could be played and/or displayed.

Referring to FIG. 3, various type controllers 20 are shown for use with the dispenser described. For example instead of the joystick with multiple buttons shown at 20A (or similar to FIG. 4C), a touch screen or pad 20B, or a “Game Pad” 20C, or steering wheel 20D, or other type controller could be used.

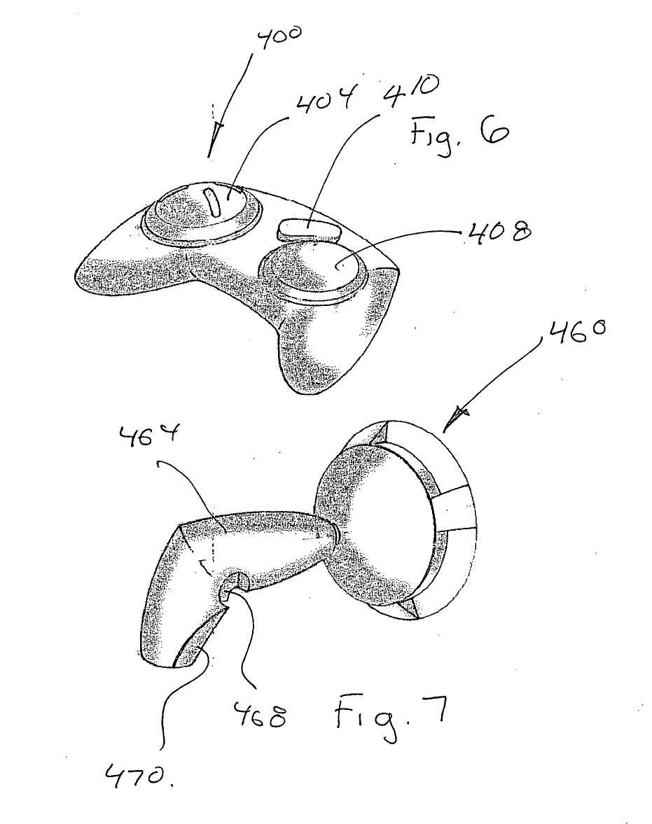

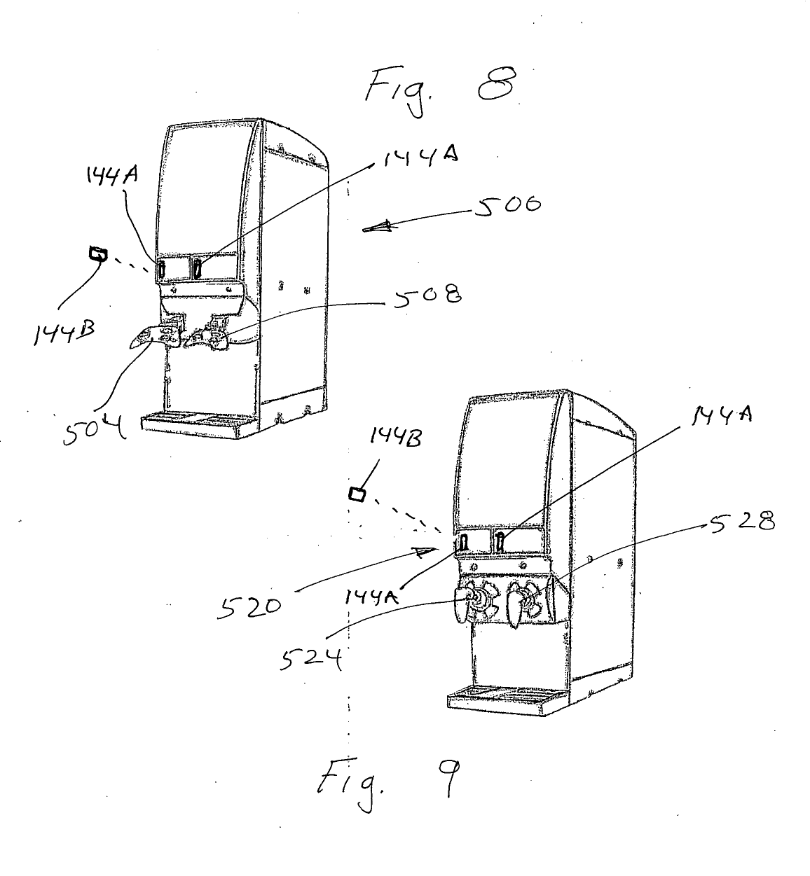

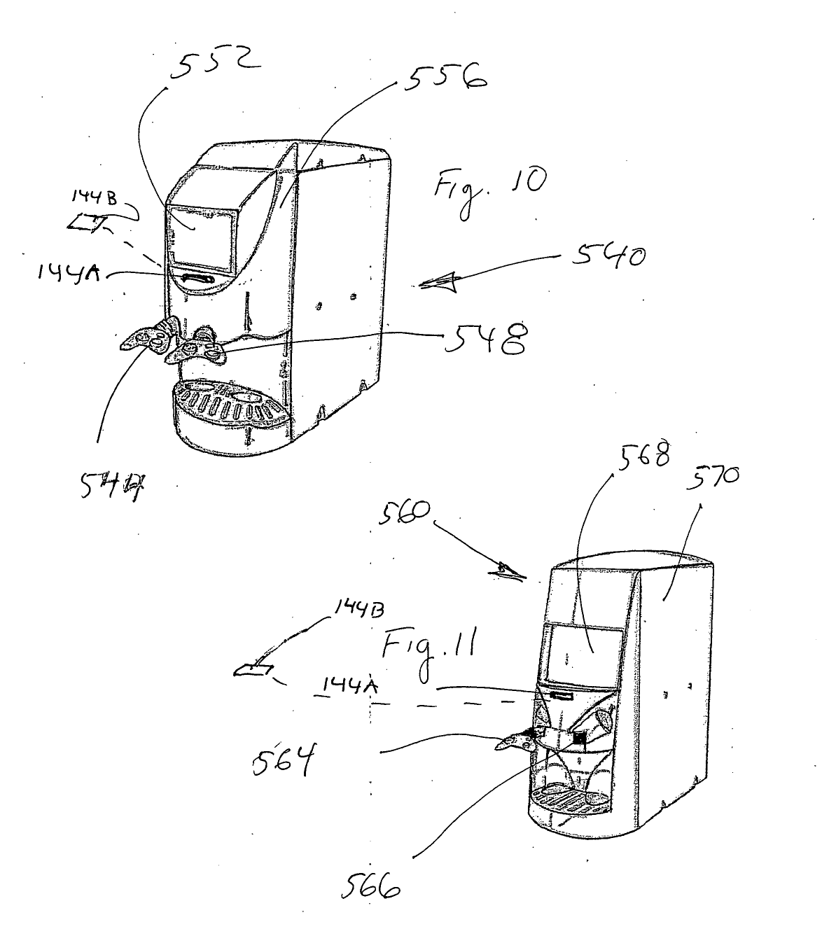

The control box 34 and controller 20 can control the flavor addition or injection through, say relays 130, 132, 134 and 136, in this instance there being four flavors source capable of being added. The controller 20 can control or operate the game displays on the monitor 125, and game audio 140, the coin or card operated vend 144, the up-down, rotate either direction, turn table mechanism 148 and/or the dispense device, such as 14, 18 or and valve 64. As to the vend unit 144, it could also feature a card slot 144A opening accessible from the exterior of the dispenser (see FIGS. 8 to 11) to receive (indicated by the dashed line) a vend/credit/debit type card 144B to cause the dispenser to be put into operation to dispense. The hardware/software to accomplish this task while not generally known in this type dispenser art, would be known to a person skilled in the vending machine art. Note each product dispensed in the dispenser shown in FIGS. 8 and 9 has its own card slot. Alternative, slots 144A could receive coins or dollars, or all these, coins, dollars or various cards. For example, the card could be a premium card given away free or at a discount to encourage usage or visitation to the established housing the dispenser. The dispenser in FIGS. 10 and 11 show a single slot 144A which would operate both or all products, and could, if desired, accommodate one or more of coins, bills and cards, such as card 144B.

Additional type controllers are shown in FIGS. 4A to 4H. They are 4A, 4B, 4E and 4G multiple button, 4C, 4F and 4H joystick and 4D lever or tiller.

The FIG. 4A design 160 features multiple flavor buttons 170, 172, 174 and 176 and electronic activation of flavors. The flavor selection buttons can be illuminated. The flow of dispensed product can be activated by pushing or pulling of the pivotable handle 178. A single housing can be used for both this customer interface and flavor injector 100. Variable flow rates can be achieved with either the position of the handle 178 or the pressing of one of the buttons.

The FIG. 4B design 162 has multiple flavors selection by flavor buttons 180, 182, 184, 186 and 188, the flavor being selected with the rotary style selection device 190. There is electronic activation of flavors. The flavor selection button can be illuminated. Product dispense is activated by push of “Go” button 191. Again, a single housing 189 can be provided for interface and flavor injector.

The FIG. 4C design 164 has multiple flavors selection when the joystick is pressed toward a flavor selection button. Flavor flow rate can be joystick 210 variable. If a flavor button 192, 194, 194, 196, 198, 200, 202, 204, or 206 is selected before flavors are, then joystick 210 direction would add flavors and change flow rate based on position from the resting point to the outer location. A flavor is selected when the joystick is pushed to the flavor location and electronic identification is made. There is electronic activation of flavors. Again, flavor selection can be illuminated. Product can be electronically dispensed or activated by push of joystick button 212. Again, a single housing for interface and flavor injector can be provided. Variable flow rates can be achieved with either the position of the joystick or the use of one of the buttons.

The FIG. 4D design 166 features multiple flavor that can be selected via flavor buttons 220, 222, 224, 226 and 228. Flavors can stay illuminated when multiple flavors are selected. Flavors are being selected by pivoting a flavor control lever 231 on the fixed wheel rim 232. Again there is electronic activation of flavors. The active flavor is magnified by lens in flavor selection magnifier 236. The product dispensed can be activated by pushing a “Go” button 240. Again, a single housing for interface and flavor injector can be provided. Variable product flow rates can be achieved with either the position of the joystick or the deflection of a button.

Controllers 260 and 280 shown in FIGS. 4E and 4G, respectively, are similar, with the former being connected to its associated dispenser by a cable 261 and with the latter mounted on the dispenser 263D. With these controllers the buttons can be used either to dispense a beverage, be it drink, beer, frozen carbonated beverage or other type or to operate one or more video games and/or video displays. For example, one of the buttons, say button 262 or 282 can be used to select the dispense/video, game, audio options. For example, buttons 263 and 283 can be used to control any one or more of eight different flavor selections. For example, the various flavors could also be selected by using buttons 265 or 285, 266 or 286, 267 or 287, 268 or 288, or the small joystick button 269 or 289. Once a flavor is selected, the beverage and selected flavor is dispensed by pushing one of the buttons 270 or 290. Thus, in one mode of button 262 or 282 the other of these buttons are used to dispense a flavored beverage, and in another mode of button 262 or 282 the other buttons can be used to play a game, say a video game.

Further, alternatively, joystick type buttons 269A and 269B or 289A and 289B could be each used to dispense a first set of four flavors (269A or 289A) and a second set of four flavors (269B or 289B).

Controllers 300 and 320 shown in FIGS. 4F and 4H, respectively, are similar with the former being connected to its associated dispenser by a cable 301 and with the latter mounted on its associated dispenser, partially shown in FIG. 4H as 301D. In these controllers the buttons can be used either to dispense a beverage, be it drink, beer, frozen carbonated beverage or other type beverage or to operate one or more video games and/or audio displays. For example, one of the buttons, say button 302 or 322 can be used to select the dispense/game/audio options. For example, buttons 305 and 325 and 308 and 328 can be used to control any one or more of different flavor selections. For example, the various flavors could also be selected by using buttons 306 or 326, 307 or 327, 308 or 328, or the joystick 312 or 332 or button 309 or 329. Once a flavor is selected, the drink beverage and selected flavor is dispensed by pushing one of the two triggers or buttons 310 or 330. Thus, in one mode of button and device 302 to 312 (FIG. 4F) or 322 to 332 (FIG. 4H), the other of these buttons are used to dispense a flavored beverage and in another mode the other buttons can be used to play a game, say a video game, or audio output. Optionally, these devices could connect with a video monitor. All the devices in FIGS. 4A to 4H could, if desired, have similar or other functions.

FIG. 5 shows a dispenser 10′ similar to dispenser 10, except instead of having the separate joystick controller 20 of FIG. 1, it has two of the interfaces 164, using joysticks like that shown in FIG. 4C. Of course, any of the interfaces or controllers shown herein, such as like 160, 162, 164 or 166 shown in FIGS. 4A, 4B, 4D, 4G or 4H could be directly mounted onto the dispenser 10′, and preferably over a respective dispensing devices 14 and 18, each including a dispenser nozzle (like 64) and flavor mixer (like 100). As is shown, the nozzles 64 are connected to the control box 34 by wires 40 and 42, while the interfaces in controller 164 are connected by wiring or cables 30 and 30′ (in this instance cables 30 and 30′ would be when installed interior of the dispenser housing). Again, a video monitor 125 for displaying games, audio output and/or dispenser operation may be optionally fitted, either as a built in for a new dispenser unit or retrofitted to an existing dispenser.

Other features could be controlled, such as selecting a carbonated or non-carbonated drink and/or the levels of carbonation by the controller 20 or one of the interfaces or controllers of FIGS. 4A to 4H, FIGS. 6 and 7.

Referring to FIG. 6, another style controller 400 is disclosed which could be connected by cable (not shown) or built into the dispenser (not shown). In this dispenser 400, one of the buttons 404 could be used to dispense one or more, of say four flavors, The button 408 could be used to dispense the beverage product. A button 410 could be used to cancel initial selections.

Referring to FIG. 7, yet another joystick style controller 460 is disclosed which could be connected by a cable (not shown) or built into the dispenser (not shown). In this controller 460, for example, moving the joystick 464 could select one of several, say eight or more flavors, while squeezing the trigger 468 could cancel a previous selection, and squeezing the handle 470, could dispense the flavored product.

While various button/trigger assignments were made above with respect to the disclosed controllers, their functions could of course be switched or swapped from the disclosed buttons/triggers to others. For example, the function of button 404 or 408 could be swapped.

Referring to FIG. 8, an existing dispenser 500 is shown retrofitted with two controllers 504 and 508 similar to that shown in FIG. 4G or FIG. 6. A video monitor (not shown) could, if desired, be also retrofitted.

Referring to FIG. 9, a dispenser 520 is shown retrofitted with two controllers 524 and 528 similar to that shown in FIG. 7. Again a video monitor (not shown), optionally, could, if desired, also be retrofitted.

Referring to FIG. 10, a dispenser 540 is shown, fitted with two controllers 544 and 548 along with a video monitor 552 flat screen or cathode ray, built into the dispenser housing 556.

Referring to FIG. 11, another dispenser 560 is shown fitted with one of two controllers 564, the other not yet having been installed or plugged in yet into the controller receiving socket 566. As noted, the controllers and dispenser could be of a modular construction permitting easy changeout for repair or even change of controller style. Again, a video monitor 568 is built into the dispenser housing 570. As shown in FIGS. 8-11, the dispensers can be provided with a slot 144A, which could accommodate (insertion being indicated by the dashed line) a coin or dollar bill or debit/credit or other card 144B to initial operation of the unit. If coin or money in bill form is provided, a coin return/refund system and slot (not shown), could be provided.

It should also be understood that the game type controller be it of the separate cable attached type or type mounted on the dispenser, could be incorporated into new dispensers and/or retrofitted to existing dispensers. Also the nozzle and flavor mix valve (such as 64 and 100) could be separate parts or integrated together, and in the latter case also integrated with a direct mount type interface, such as is shown, for example, in any of FIGS. 4A and/or 4D, or other figures of the drawings.

What is claimed is:

1. A dispenser for a beverage, comprising a housing and at least one beverage product source, a dispensing nozzle, said beverage product being dispensable through a dispensing nozzle, a controller and a control, and the controller and control operating to dispense said product through said nozzle, one or more sources of flavors, the controller and control operating to dispense said one or more sources of flavor into said product.

2. A dispenser as in claim 1, wherein product flavor is dispensed into said product one of before, within or after said nozzle.

3. A dispenser as in claim 2, wherein said controller is a game type controller.

4. A dispenser as in claim 3, wherein said game type controller is one of a joystick, lever, and multiple button controllers.

5. A dispenser as in claim 1, wherein said dispenser is an existing dispenser and said controller is retrofitted to said dispenser.

6. A dispenser as in claim 1, wherein said controller and control are built into said dispenser when said dispenser is manufactured.

7. A dispenser as in claim 1, wherein said dispenser, controller and said control in addition to dispensing can control one of game functions and audio functions.

8. A dispenser as in claim 1, further comprising means for one of coin, dollar bill, debit card, and credit card means for operating said dispenser.

9. A dispenser as in claim 1, wherein said product is one of drink, soda, slushy type product, semi-frozen, frozen product, iced product and carbonated beverage.

10. A dispenser as in claim 1, wherein said controller is directly mounted on said dispenser.

11. A dispenser as in claim 10, wherein said controller is mounted adjacent said nozzle.

12. A dispenser as in claim 1, wherein said controller is remote from said dispenser.

13. A dispenser as in claim 12, wherein said controller is connected to said control by a cable.

14. A dispenser as in claim 1, further including a video monitor.

15. A dispenser as in claim 1, wherein said dispenser includes a flavor mixing means for mixing said product and said flavor.

16. A dispenser as in claim 15, wherein said flavor mixing means is adjacent said nozzle.

17. A dispenser as in claim 15, wherein said flavor mixing means is downstream of said nozzle.

18. A dispenser as in claim 1, wherein said controller can control rotation of the cup into which said product is dispensed.

19. A dispenser as in claim 1, wherein said controller can control the raising or lowering of the cup into which said product is dispensed.

20. A dispenser as in claim 1, wherein said controller is one of a joystick, lever, multiple button, wheel, pad and touch screen.

21. A dispenser as in claim 1, wherein said controller controls the flow of said product.

22. A dispenser as in claim 1, wherein said controller controls the flow of said flavor.

23. A dispenser as in claim 21, wherein said flow is variable.

24. A dispenser as in claim 1, wherein said dispenser could be operated by two or more controllers of different types.

25. A dispenser for a beverage, comprising a housing and at least one beverage product source, a dispensing nozzle, said beverage product being dispensable through a dispensing nozzle, a game type controller and a control, and game type controller and control operating to dispense said product through said nozzle.

26. A dispenser as in claim 25, wherein said game type controller is one of a joystick, lever, multiple button, wheel, pad, and touch screen.

27. A dispenser as in claim 25, wherein said dispenser is an existing dispenser and said game type controller is retrofitted to said dispenser.

28. A dispenser as in claim 25, wherein said game type controller and control are built into said dispenser when said dispenser is manufactured.

29. A dispenser as in claim 25, wherein said dispenser, said game type controller, and said control in addition to dispensing can control one of game functions and audio functions.

30. A dispenser as in claim 25, further comprising means for one of coin, dollar bill, debit card, premium credit card or other card means for operating said dispenser.

31. A dispenser as in claim 25, wherein said product is one of drink, soda, slushy type product, semi-frozen, frozen product, iced product and carbonated beverage.

32. A dispenser as in claim 25, wherein said game type controller is directly mounted on said dispenser.

33. A dispenser as in claim 32, wherein said game type controller is mounted adjacent said nozzle.

34. A dispenser as in claim 25, wherein said game type controller is remote from said dispenser.

35. A dispenser as in claim 25, further including a video monitor.

36. A dispenser as in claim 25, wherein said dispenser includes a flavor adding means for adding flavor to said product and a flavor mixing means for mixing said product and said flavor.

37. A dispenser as in claim 36, wherein said flavor mixing means is adjacent said nozzle.

38. A dispenser as in claim 36, wherein said flavor mixing means is downstream of said nozzle.

39. A dispenser as in claim 25, wherein said game type controller can control rotation of the cup into which said product is dispensed.

40. A dispenser as in claim 25, wherein said game type controller can control the raising or lowering of the cup into which said product is dispensed.

41. A dispenser as in claim 25, wherein said game type controller controls the flow of said product.

42. A dispenser as in claim 41, wherein said game type controller controls the flow of said flavor.

43. A dispenser as in claim 41, wherein said flow is variable.

44. A dispenser as in claim 25, wherein there are up to as many as eight flavors and said game type controller and control, control the dispense of up to as many as eight flavors.

45. A dispenser as in claim 25, wherein said game type controller and dispenser are of modular construction permitting each changeout.

46. A dispenser as in claim 25, wherein said dispenser could be operated by two or more game type controllers of different types.

47. A method for dispensing a beverage, comprising the steps of providing a dispenser with a beverage source and a dispensing nozzle, providing a game type controller, controlling dispensing of the beverage through said beverage nozzle with the game type controller, and operating the game type controller to dispense the beverage product through the nozzle.

48. A method as in claim 47, further comprising the step of dispensing flavor into said product one of before, within or after said nozzle.

49. A method as in claim 47, further comprises the step of retrofitting an existing dispenser with said controller.

50. A method as in claim 47, further comprising the step of installing said control into said dispenser when said dispenser is manufactured.

51. A method as in claim 47, using said dispenser, controller and said control to in addition to dispensing product, controlling one of game functions and audio functions.

52. A method as in claim 47, further comprising the step of using one of coin, dollar bill, debit card, credit card or other card means for operating said dispenser.

53. A dispenser as in claim 47, wherein said dispenser dispensing one of drink, soda, slushy type product, semi-frozen product, frozen product, iced product and carbonated beverage.

54. A method as in claim 47, further including the step of providing a video monitor for said dispenser.

55. A method as in claim 47, further comprising the step of providing said dispenser with a flavor mixing means for mixing said product and said flavor.

56. A method as in claim 55, comprising locating said flavor mixing means adjacent said nozzle.

57. A method as in claim 56, comprising the step of locating said flavor mixing means downstream of said nozzle.

58. A method as in claim 47, comprising the step of providing said dispenser with multiple flavors, and controlling said flavors with said controller and said control.

59. A method as in claim 47, using said controller for rotating the cup into which said product is dispensed.

60. A method as in claim 47, using said controller for raising or lowering of the cup into which said product is dispensed.

61. A method as in claim 47, comprising the step of using said controller and controlling the flow of said product.

62. A method as in claim 47, comprising the step of using said controller and controlling the flow of said flavor.

63. A method as in claim 47, comprising the step of using said controller and controlling the amount of said flavor dispensed.

64. A method as in claim 62, comprising the step of varying said flow with said controller.

65. A method as in claim 63, comprising the step of varying said amount with said controller.

66. A method as in claim 47, of making said controller and dispenser of modular construction permitting each changeover.

67. A method as in claim 47, making said dispenser to be operated by two or more controllers of different types.
